(19) United States
(12) Patent Application Publication
(10) Pub. No.: US 2022/0129124 A1
(43) Pub. Date: Apr. 28, 2022

(54) CONTROL DEVICE, SYSTEM, AND PROGRAM

(71) Applicant: KABUSHIKI KAISHA TOKAI RIKA DENKI SEISAKUSHO, Aichi (JP)

(72) Inventors: Keiji NOMURA, Aichi (JP); Toshihito TAKAI, Aichi (JP); Kenji MURATA, Aichi (JP); Keita NAKANE, Aichi (JP)

(73) Assignee: KABUSHIKI KAISHA TOKAI RIKA DENKI SEISAKUSHO, Aichi (JP)

(21) Appl. No.: 17/430,928

(22) PCT Filed: Mar. 2, 2020
(86) PCT No.: PCT/JP2020/008674

§ 371 Date: Aug. 13, 2021

(30) Foreign Application Priority Data
Mar. 26, 2019 (JP) 2019-059343
Feb. 28, 2020 (JP) 2020-033494

(51) Int. Cl. G06F 3/0484; G06F 3/04883; G06F 3/01

(52) U.S. Cl. CPC G06F 3/0484; G06F 3/016; G06F 3/04883

(57) ABSTRACT

Operability is further improved.

There is provided a control device that includes: an acceptance section configured to accept an operation on at least one operation section; and a control section configured to control a notification section to perform notification matching a situation of a series of continuous operations accepted by the acceptance section.

### TECHNICAL FIELD

The present invention relates to a control device, a system, and a program.

### BACKGROUND ART

In recent years, multiple systems that employ Graphical User Interfaces (GUIs) are developed. For example, Patent Literature 1 discloses a system that can execute a function corresponding to a command input option displayed on a monitor by operating a touchpad.

Furthermore, according to the system disclosed by Patent Literature 1, an input field corresponding to the above command input option is arranged on the touchpad, and, when a user touches the input field, notification is performed for the user who performs an operation, and the function corresponding to the above command input option is executed. According to this control, the user can perform a desired operation without gazing at a monitor at all times.

### CITATION LIST

### Patent Literature

Patent Literature 1: JP 2003-108311

### SUMMARY OF INVENTION

### Technical Problem

However, when the above-described system continues notification of the same mode in response to a series of continuous operations, there is a likelihood that the user cannot grasp an acceptance situation or a process situation related to a series of operations performed by the user, and operability lowers.

Therefore, the present invention has been made in light of the above problem, and an object of the present invention is to provide a mechanism that can further improve operability.

### Solution to Problem

To solve the above task, a certain aspect of the present invention provides a control device that includes: an acceptance section configured to accept an operation on at least one operation section; and a control section configured to control a notification section to perform notification matching a situation of a series of continuous operations accepted by the acceptance section.

Furthermore, to solve the above task, another aspect of the present invention provides a system that includes: at least one operation section; an acceptance section configured to accept an operation on the operation section; a notification section configured to perform notification for a user who performs the operation; and a control section configured to control the notification section to perform notification matching a situation of a series of continuous operations accepted by the acceptance section.

Furthermore, to solve the above task, still another aspect of the present invention provides a program that causes a computer to realize: an acceptance function configured to accept an operation on at least one operation section; and a control function configured to control a notification section to perform notification matching a situation of a series of continuous operations accepted by the acceptance function.

### Advantageous Effects of Invention

According to the present invention, it is possible to further improve operability.

### BRIEF DESCRIPTION OF DRAWINGS

FIG. 1 is a diagram illustrating a functional configuration example of a system according to the present embodiment.

FIG. 2 is a diagram illustrating an example of notification control matching a situation of a series of operations according to the present embodiment.

FIG. 3A is a view for explaining control of progress notification matching a progress situation of a swipe operation according to the present embodiment.

FIG. 3B is a view for explaining control of progress notification matching the progress situation of the swipe operation according to the present embodiment.

FIG. 4 is a flowchart schematically illustrating a flow of an operation of the system according to the present embodiment.

FIG. 5 is a flowchart schematically illustrating a flow of notification control of the control section according to the present embodiment.

### DESCRIPTION OF EMBODIMENTS

A preferred embodiment of the present invention will be described below in detail with reference to the accompanying drawings. In addition, components having substantially identical functional configurations will be assigned identical reference numerals in the description and the drawings, and overlapping description will be omitted.

### EMBODIMENT

### Configuration Example

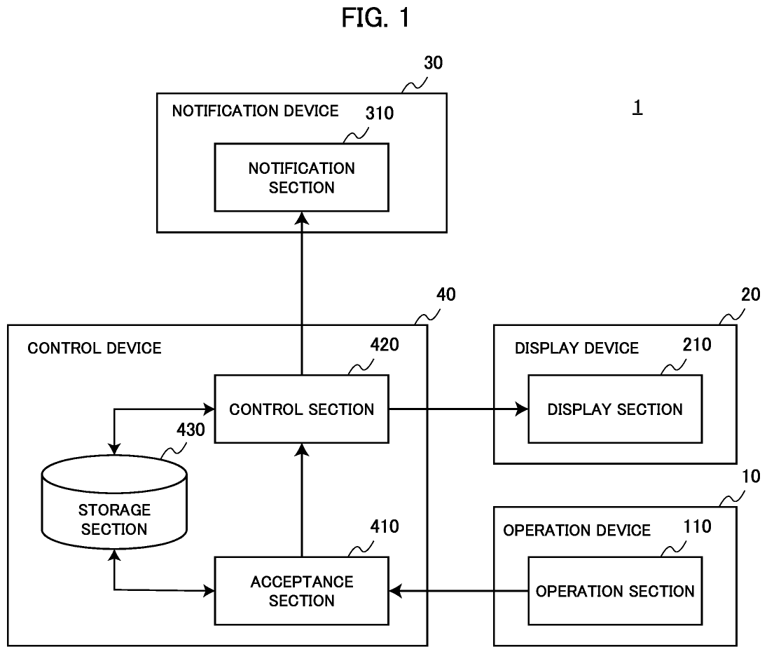

First, a configuration example of a system 1 according to an embodiment of the present invention will be described. FIG. 1 is a diagram illustrating a functional configuration example of the system 1 according to the present embodiment. As illustrated in FIG. 1, the system 1 according to the present embodiment includes, for example, an operation device 10, a display device 20, a notification device 30, and a control device 40.

(Operation Device 10)

The operation device 10 according to the present embodiment is a target device for which a user executes an operation. The system 1 according to the present embodiment may include the at least one or more operation devices 10. The operation device 10 according to the present embodiment may be, for example, a touchpad, a trackball, a mouse, a wheel, or a slide switch. The operation device 10 according to the present embodiment includes an operation section 110.

The operation section 110 according to the present embodiment includes a function of detecting the user's operation. Hence, the operation section 110 may include various detection mechanisms that match modes of the operation device 10. When, for example, the operation device 10 is the touchpad, the operation section 110 may include a pressure sensor that changes a pressure that changes following the user's operation to an electric signal, and a capacitive sensor that converts a change of a capacitance that changes following the user's operation into an electric signal. Furthermore, the operation section 110 may include a switch that detects a user's push operation. The operation section 110 transmits a signal related to the detected user's operation to the control device 40.

(Display Device 20)

The display device 20 according to the present embodiment is a device that displays visual information such as an image. The display device 20 according to the present embodiment may be various display devices. The display device 20 according to the present embodiment includes a display section 210.

The display section 210 according to the present embodiment may display an image based on a signal input from the control device 40.

(Notification Device 30)

The notification device 30 according to the present embodiment is a device that performs various types of notification to the user according to control performed by the control device 40. The notification device 30 according to the present embodiment includes a notification section 310.

The notification section 310 according to the present embodiment performs notification based on a control signal input from the control device 40. Hence, the notification section 310 includes various output mechanisms that match notification modes. In a case where, for example, the notification section 310 executes notification via a user's tactile sense, the notification section 310 may include various actuators that can generate, for example, a vibration stimulation, an electric stimulation, a pressure stimulation, and a thermal stimulation. In a case where, for example, the notification section 310 performs notification that uses the vibration stimulation, the notification section 310 may include an Eccentric Rotating Mass (ERM), a Linear Resonant Actuator (LRA) or a piezoelectric element, and a voice coil motor. Furthermore, the notification section 310 may include a plurality of actuators of the same type or different types.

Furthermore, in a case where, for example, the notification section 310 executes notification via a user's sense of hearing, the notification section 310 may include a speaker or an amplifier. Furthermore, in a case where, for example, the notification section 310 executes notification via a user's visual sense, the notification section 310 may include various lightings that emit light.

In addition, notification performed by the notification section 310 may be a combination of stimulations of a plurality of different modes. For example, the notification section 310 may execute notification that uses vibration and sound. Furthermore, for example, the notification section 310 may execute notification that uses an electric stimulation and light. The notification section 310 according to the present embodiment performs notification that uses at least one of vibration, sound, and light based on control performed by the control device 40.

(Control Device 40)

The control device 40 according to the present embodiment is a device that accepts a user's operation on the operation device 10 and executes control matching the operation. The control device 40 according to the present embodiment includes an acceptance section 410, a control section 420, and a storage section 430.

The acceptance section 410 according to the present embodiment includes a function of accepting an operation on the at least one operation section 110. For example, the acceptance section 410 receives an electric signal generated by the operation section 110 based on the detected user's operation, and accepts an operation corresponding to the electric signal. Furthermore, the operations accepted by the acceptance section 410 according to the present embodiment include a series of continuous operations including a plurality of operations. One example of the above series of continuous operations includes, for example, a trace operation including touch of an operation object on the operation section 110 and movement in a state where the operation object is placed in contact with the operation section 110. One example of the above operation object is a user's finger or a pen-shaped tool.

The control section 420 according to the present embodiment performs various types of control matching contents of an operation accepted by the acceptance section 410. The control section 420 according to the present embodiment may control the notification section 310 to perform notification matching, for example, a series of continuous operations accepted by the acceptance section 410. A function of the control section 420 may be realized by collaboration of, for example, a processor such as a Central Processing Section (CPU) and a Random Access Memory (RAM). Notification control performed by the control section 420 according to the present embodiment will be separately described in detail.

The storage section 430 according to the present embodiments stores various pieces of information related to operations of the control device 40. The storage section 430 stores, for example, a program for causing the control section 420 to execute a notification process.

The functional configuration example of the system 1 according to the present embodiment has been described above. In addition, the functional configuration described using FIG. 1 is only an example, and the functional configuration of the system 1 according to the present embodiment is not limited to this example. For example, the operation device 10 and the notification device 30 may be formed as an integrated device. In this case, by, for example, executing notification that uses a vibration stimulation, it is possible to realize notification as feedback to the user's operation on the operation device 10. The functional configuration of the system 1 according to the present embodiment can be flexibly modified according to a specification or an operation.

<<Details>>

Next, the function of the system 1 according to the present embodiment will be described in detail. Note that a case where the system 1 according to the present embodiment is applied to a car compartment of a movable body such as a vehicle will be described as a main example below. For example, the at least one or more operation sections 110 may be provided to a spoke of a steering. Furthermore, the notification section 310 may be formed integrally with the operation section 110, and perform notification using a vibration stimulation. Furthermore, the display section 210 may be provided as (part of) an instrument panel, or may be provided to a center console.

Hereinafter, a case is assumed where the user performs a series of operations on the operation section 110 to cause the system 1 to execute some function. The above series of operations may include a trace operation where, for example, an operation object such as a finger moves from a first rim in an operation area of the operation section 110 toward a second rim different from the first rim.

Furthermore, the above trace operation may correspond to a swipe operation of, for example, sliding a target image from one end toward the other end of a display area of the display section 210 arranged separately from the operation section 110. The above target image may be, for example, an image that is superimposed and displayed in front of an image displayed before the swipe operation while being slid by the swipe operation.

In this case, it is also possible to cause the notification section 310 to continue notification of the same mode while the above-described swipe operation is performed. Accordingly, the user can intuitively grasp that the swipe operation performed by the user is accepted.

However, according to the above-described notification control, when the user is not gazing at the display area, it is difficult to grasp whether or not the target image is properly slid. Furthermore, in this case, there is also a likelihood that the user cannot grasp a situation that the target image has been completely slid, that is, that the target image cannot be slid any more, and continues an unnecessary swipe operation.

Hence, the control section 420 according to the present embodiment may control the notification section 310 to perform notification matching a situation of a series of continuous operations accepted by the acceptance section 410.

In one example, the control section 420 according to the present embodiment may cause the notification section 310 to perform start point notification that indicates an operation start of a series of operations, progress notification that indicates an operation progress situation of the same series of operations, and end point notification that indicates an operation end point of the same series of operations.

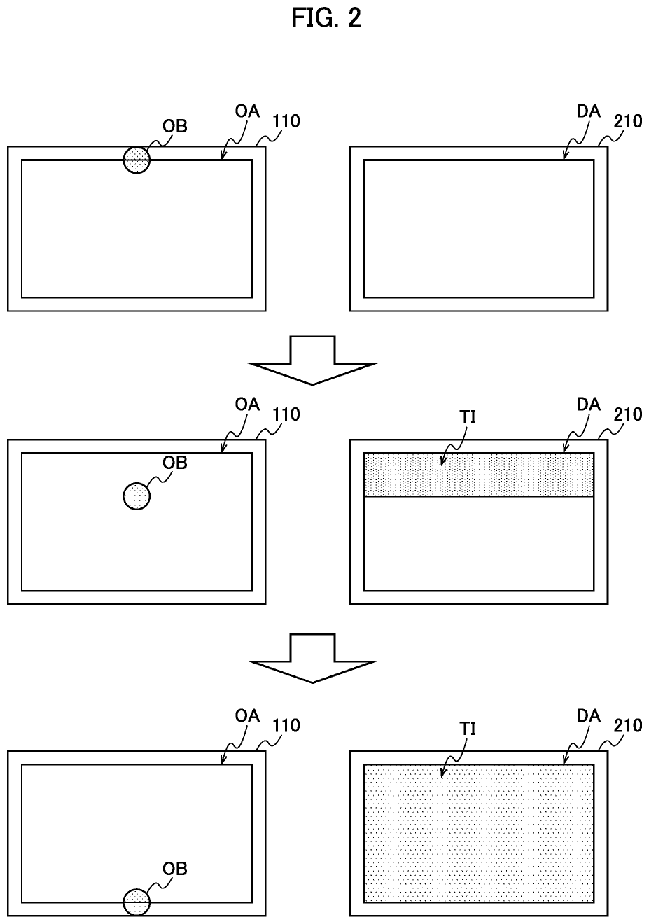

The description continues below by citing a specific example using FIG. 2. FIG. 2 is a diagram illustrating one example of notification control matching a situation of a series of operations according to the present embodiment. Note that FIG. 2 exemplifies notification control in a case where the user performs the above-described swipe operation.

A left column in FIG. 2 illustrates a position of an operation object OB such as a finger that changes in response to the user's swipe operation (trace operation) in an operation area OA of the operation section 110. On the other hand, a right column in FIG. 2 illustrates that a display area DA of the display section 210 changes in response to the above swipe operation. Note that FIG. 2 exemplifies a case where the user performs the swipe operation of moving the operation object from an upper rim to a lower rim of the operation area OA. That is, in the example illustrated in FIG. 2, the upper rim of the operation area OA corresponds to a first rim, and the lower rim corresponds to a second rim.

In this case, as illustrated in the left column in an upper part in FIG. 2, the user first places the operation object in contact with the first rim (upper rim) of the operation area OA as start of the swipe operation. In this case, the control section 420 according to the present embodiment may cause the notification section 310 to perform start point notification that indicates the start of the swipe operation. According to this control, the user can intuitively grasp that the start of the user's swipe operation has been properly accepted.

The above start point notification may be notification via a user's tactile sense. In this case, for example, the control section 420 may cause the notification section 310 to perform start notification that imitates a tactile sense of grabbing a target image TI (or some object). Furthermore, for example, the control section 420 may cause the notification section 310 to perform start notification that imitates a tactile sense that the target image TI is absorbed to the operation object OB. The above-described start point notification can be expressed by appropriately controlling a parameter related to tactile sense presentation. When start point notification that uses a vibration stimulation is performed, one example of the above parameter is an acceleration, a frequency, a vibration time, or the number of times of vibration.

Note that the target image TI may be, for example, an image that is superimposed and displayed in front of an image displayed in the display area DA before the swipe operation while being slid (drawn) from the upper end toward the lower end of the display area DA by the swipe operation. As illustrated in the right column in the upper part in FIG. 2, the target image TI may not be displayed in the display area DA at a point of time at which start notification is performed. On the other hand, part of the target image TI may be displayed near the upper end of the display area DA before swiping starts.

Next, as illustrated in the left column in a middle part in FIG. 2, the user moves the operation object OB toward the second rim (lower rim) of the operation area OA. Following this movement, the target image TI is drawn from the upper end toward the lower end of the display area DA as illustrated in the right column in the middle part in FIG. 2. Note that a movement amount (drawing amount) of the target image TI in the display area DA corresponds to a movement amount of the operation object OB in the operation area OA. That is, when the movement amount of the operation object OB in the operation area OA is larger, the target image TI is drawn more.

In this case, the control section 420 according to the present embodiment may cause the notification section 310 to perform progress notification that indicates a progress situation of the swipe operation. For example, the control section 420 may cause the notification section 310 to perform progress notification that imitates a tactile sense of dragging the target image TI. The progress notification may be notification accompanied by a vibration stimulation that makes the user perceive a feel of roughness. Until the operation object OB arrives at the second rim of the operation area OA, the control section 420 may cause the notification section 310 to continue performing the progress notification. According to this control, the user can intuitively grasp that the target image TI is properly drawn by the user's swipe operation without gazing at the display area DA.

Subsequently, when the operation object OB arrives at the second rim of the operation area OA as illustrated in the left column in the lower part in FIG. 2, the target image TI is drawn in the display area DA and cannot be drawn any more as illustrated in the right column in the lower part in FIG. 2. In this case, the control section 420 according to the present embodiment may cause the notification section 310 to perform end point notification that indicates an end point of the swipe operation. For example, the control section 420 may cause the notification section 310 to perform end point notification that imitates a feel that the target image TI cannot be drawn. The progress notification may be notification accompanied by a vibration stimulation that makes the user perceive a sense that the operation object OB contacts an object that exists in a movement direction. According to this control, the user can intuitively grasp that the target image TI has been completely drawn without gazing at the display area DA, and it is possible to prevent the user from unnecessarily continuing the swipe operation.

Notification control matching the situation of a series of operations according to the present embodiment has been described above citing the example. Note that FIG. 2 illustrates the example of the case where the first rim and the second rim in the operation area OA are the upper rim and the lower rim in the operation area OA, respectively, and the target image TI is drawn from the upper rim toward the lower rim of the display area DA. However, the first rim, the second rim, and an image sliding direction according to the present embodiment are not limited to this example. The first rim according to the present embodiment may be any rim in the operation area OA, and the second rim may be a rim different from the first rim. Furthermore, the sliding direction of the target image TI may not be necessarily a direction that travels from the first rim toward the second rim, and, for example, the image may be slid in a direction that travels from the second rim toward the second direction.

Furthermore, the case where the control section 420 causes the notification section 310 to perform notification via a user's tactile sense has been exemplified above. On the other hand, notification according to the present embodiment may be notification that uses sound or light, or may be notification that uses a combination of, for example, vibration, sound, and light.

For example, the control section 420 may cause the notification section 310 to perform notification that uses sound caused when the operation object OB grabs the target image TI or single weak light in addition to or instead of the above-described vibration stimulation as the start point notification.

Furthermore, for example, the control section 420 may cause the notification section 310 to perform notification that uses sound that imitates sound caused when the operation object OB moves on paper or continuous or discontinuous light in addition to or instead of the above-described vibration stimulation as the progress notification.

For example, the control section 420 may cause the notification section 310 to perform notification that uses sound that imitates sound caused when the operation object OB hits against an object or stronger light than light used for start notification in addition to or instead of the above-described vibration stimulation as the end point notification. Notification according to the present embodiment can be flexibly modified according to the specification or the operation.

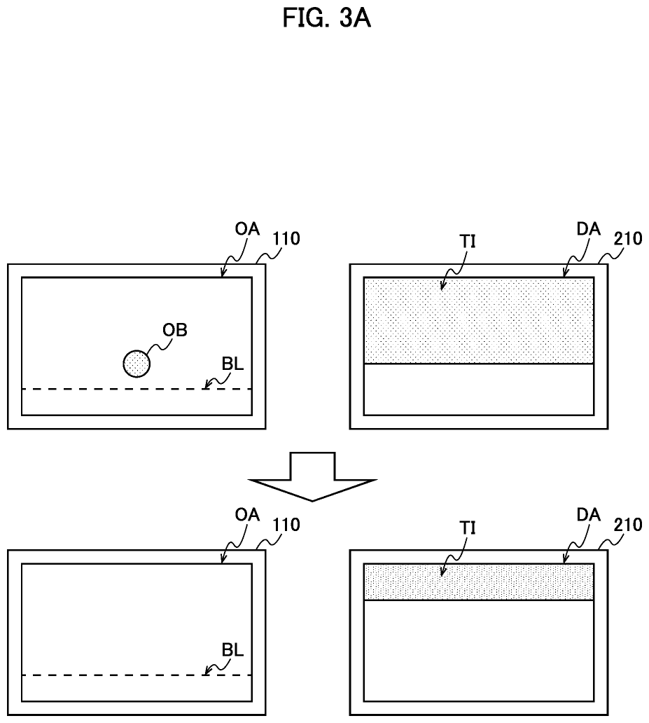

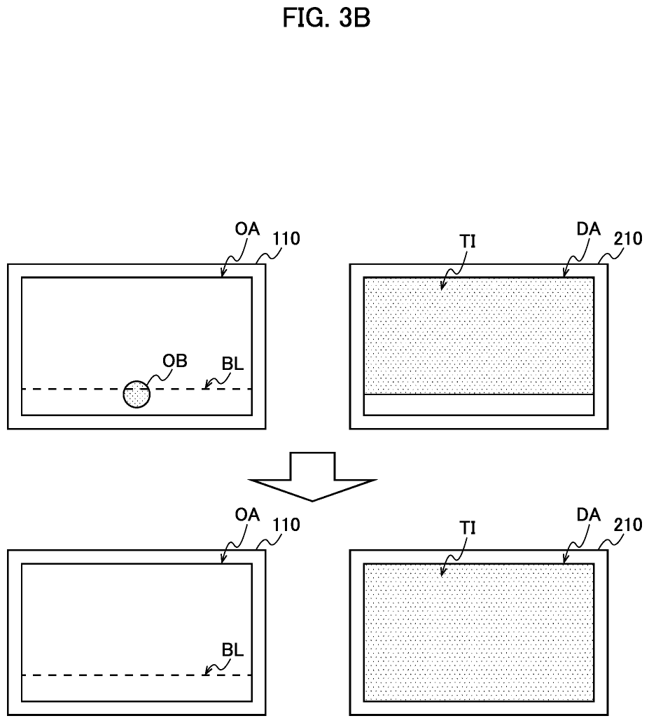

Furthermore, the control section 420 according to the present embodiment may change the mode of the progress notification according to the progress situation of the swipe operation. FIGS. 3A and 3B are diagrams for explaining control of the progress notification matching the progress situation of the swipe operation according to the present embodiment.

In this regard, a case is assumed where, when the target image TI arrives at a borderline BL defined in the display area DA, a drawing process subsequently continues even though the user does not perform an operation, and the target image TI is completely drawn.

In this case, when, for example, the operation object OB moves from the first rim (upper rim) toward the second rim (lower rim) of the operation area OA as illustrated in the left column in the upper part in FIG. 3A, the control section 420 may cause the notification section 310 to perform afore-mentioned progress notification in a situation that the operation object OB is located on a side closer to the first rim than to the borderline BL.

Note that, when the above situation changes to a situation that the operation object OB moves out of the operation area OA and the position of the operation object OB cannot be detected as illustrated in the left column in the lower part in FIG. 3A, the target image TI may be drawn back toward the upper end of the display area DA as illustrated in the right column in the lower part in FIG. 3A. In this case, the operation object OB is not in contact with the operation area OA, and therefore the control section 420 may cause the notification section 310 to perform notification that uses sound or light instead of a vibration stimulation, and notify the user of that the operation object OB has moved out of the operation area OA. According to this control, in, for example, a situation that the user has unintentionally moved the operation object OB out of the operation area OA, it is possible to make the user more quickly recognize the situation.

On the other hand, when the operation object OB moves from the first rim (upper rim) toward the second rim (lower rim) of the operation area OA as illustrated in the left column in the upper part in FIG. 3B, and when the operation object OB arrives at the borderline BL, the control section 420 may change the mode of the progress notification. The control section 420 may cause the notification section 310 to perform progress notification of a different mode from the progress notification performed before an arrival at the borderline BL. The progress notification in a situation that the operation object OB has arrived at the borderline BL may be, for example, notification that makes the user perceive a sense that a weight of an object that has been dragged lightens.

When the operation object OB arrives at the borderline BL, and even when the operation object OB moves out of the operation area OA as illustrated in the left column in a lower part in FIG. 3B, a drawing process of the target image TI is automatically performed continuously, and the target image TI is completely drawn as illustrated in a right column in the lower part in FIG. 3B. Consequently, according to a change of the mode of the above-described progress notification for which the borderline BL serves as a reference line, the user can intuitively grasp a state where the target image TI is automatically drawn by the swipe operation, and stop the swipe operation.

Note that a time lag occurs more or less until the target image TI is automatically drawn completely after the operation object OB arrives at the borderline BL. Hence, when the target image TI is completely drawn, the control section 420 may cause the notification section 310 to perform end point notification in addition to progress notification at a point of time at which the operation object OB arrives at the borderline BL. In this case, when the operation object OB is detected in the operation area OA, the control section 420 may cause the notification section 310 to perform end point notification that uses a vibration stimulation of a different mode from a vibration stimulation used for the progress notification at the point of time at which the operation object OB arrives at the borderline BL. On the other hand, when the operation object OB is not detected in the operation area OA, the control section 420 may cause the notification section 310 to perform end point notification that uses sound or light.

As described above, the control section 420 according to * can change the mode of the progress notification according to the progress situation of the swipe operation. Note that control described using FIGS. 3A and 3B are only the example, and the change of the mode of the progress notification matching the progress situation of the swipe operation according to the present embodiment is not limited to this example. The control section 420 can also continuously change the mode of progress notification according to the progress situation of the swipe operation. When, for example, performing progress notification that makes the user perceive a sense of dragging an object, the control section 420 may control various parameters related to the progress notification such that the user feels that a weight of the object is heavier when a detection position of the operation object OB is closer to the first rim or the user feels that the weight of the object is lighter when the detection position of the operation object OB is closer to the second rim.

Furthermore, the case where the control section 420 performs notification control matching the situation of the swipe operation has been mainly described above citing the swiping operation for drawing the target image as one of the series of operations. However, the series of operations according to the present embodiment is not limited to the above swipe operation. Another example of the series of operations according to the present embodiment includes a pinch-out operation of enlarging an image displayed on the operation area OA, and a pinch-in operation of reducing the image.

In a case of, for example, the pinch-out operation, the control section 420 may cause the notification section 310 to perform start point notification when two operation objects are detected in the operation area OA, progress notification matching a situation that a distance between the two operation objects increases, or end point notification when an enlargement ratio of the image reaches a limit as the pinch-out operation is performed.

In a case of, for example, the pinch-in operation, the control section 420 may cause the notification section 310 to perform start point notification when two operation objects are detected in the operation area OA, progress notification matching a situation that a distance between the two operation objects decreases, or end point notification when a reduction ratio of the image reaches a limit as the pinch-in operation is performed.

Notification control according to the present embodiment is widely applicable to a series of various continuous operations.

<<Flow of Operation>>

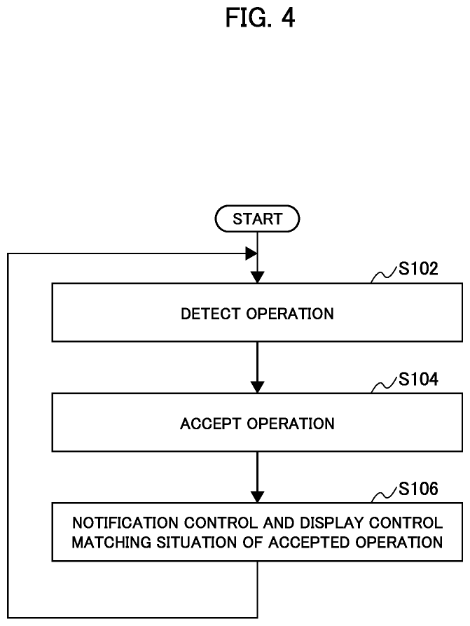

Next, a flow of the operation of the system 1 according to the present embodiment will be described. FIG. 4 is a flowchart schematically illustrating the flow of the operation of the system 1 according to the present embodiment.

As illustrated in FIG. 4, the operation section 110 first detects a user's operation (S102). The operation section 110 outputs a signal related to the detected operation to the acceptance section 410.

Next, the acceptance section 410 accepts the operation corresponding to the signal based on the signal input in step S102 (S104). The acceptance section 410 inputs information related to the accepted operation to the control section 420.

Next, the control section 420 performs notification control and display control matching an operation situation based on the information input in step S104 (S106). Note that the display control in step S106 may not be necessarily performed by the control section 420, and may be performed by another component that has received the information related to the operation from the acceptance section 410.

The system 1 according to the present embodiment may repeatedly execute above steps S102 to S106 until an end of the operation is instructed.

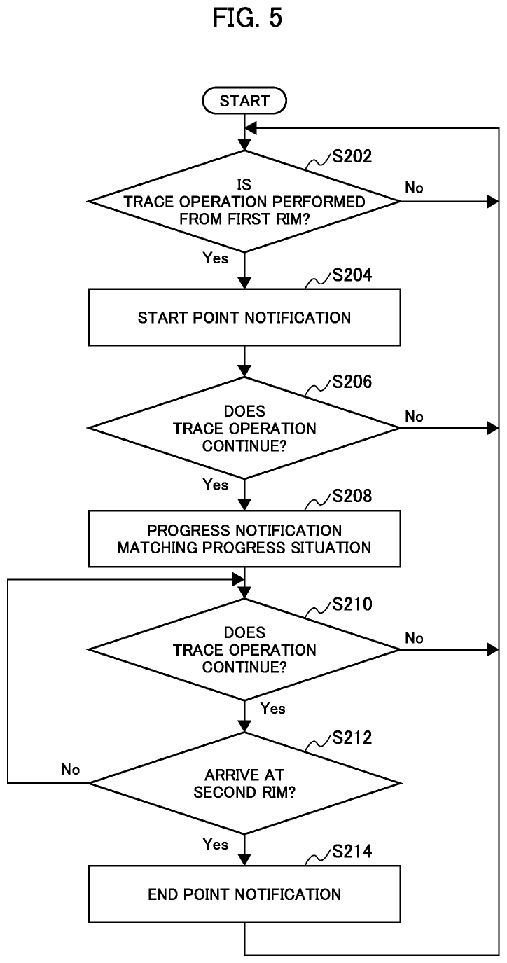

Next, a flow of the notification control of the control section 420 according to the present embodiment will be described in detail using FIG. 5. FIG. 5 is a flowchart illustrating a flow of the notification control of the control section 420 according to the present embodiment. Note that FIG. 5 exemplifies an example of a case where a series of operations are the above-described trace operation (swipe operation).

As illustrated in FIG. 5, the control section 420 first decides whether or not the trace operation is performed starting from the first rim of the operation area OA based on the information input from the acceptance section 410 (S202).

In this regard, when deciding that the trace operation is not performed (S202: No), the control section 420 returns to step S202.

On the other hand, when deciding that the trace operation is performed starting from the first rim (S206: Yes), the control section 420 causes the notification section 310 to perform start point notification (S204).

Next, the control section 420 decides whether or not the trace operation continues based on the information input from the acceptance section 410 (S206).

In this regard, when deciding that the trace operation does not continue (S206: No), the control section 420 returns to step S202.

On the other hand, when deciding that the trace operation continues (S206: Yes), the control section 420 causes the notification section 310 to perform progress notification matching a progress situation of the trace operation (S208). Note that the control section 420 may change the mode of the progress notification that the control section 420 causes the notification section 310 to perform, according to the above-described progress situation of, for example, the arrival at the borderline BL.

Next, the control section 420 decides again whether or not the trace operation continues based on the information input from the acceptance section 410 (S210).

In this regard, when deciding that the trace operation does not continue (S210: No), the control section 420 returns to step S202.

On the other hand, when deciding that the trace operation continues (S210: Yes), the control section 420 subsequently decides whether or not the operation object OB has arrived at the second rim of the operation area OA based on the information input from the acceptance section 410 (S212).

In this regard, when deciding that the operation object OB does not arrive at the second rim of the operation area OA (S210: No, the control section 420 returns to step S210.

On the other hand, when deciding that the operation object OB has arrived at the second rim of the operation area OA (S212: Yes), the control section 420 is caused to perform end point notification (S214).

The system 1 according to the present embodiment may repeatedly execute above steps S202 to S214 until the end of the operation is instructed.

<Supplementary Explanation>

Heretofore, the preferred embodiment of the present invention has been described in detail with reference to the appended drawings. However, the present invention is not limited to this embodiment. It should be understood by those who have common knowledge in the technical field to which the present invention belongs that it is obvious that various change examples and alteration examples can be arrived at within the scope of the technical idea recited in the claims, and these change examples and alteration examples also naturally belong to the technical scope of the present invention.

Furthermore, a series of processes of each device described in this description may be realized by using one of software, hardware, and a combination of the software and the hardware. Programs that configure the software are stored in advance in, for example, a non-transient storage medium provided inside or outside each device. Furthermore, each program is read on an RAM when, for example, executed by a computer, and is executed by a processor such as a CPU. The above storage medium is, for example, a magnetic disk, an optical disk, a magneto-optical disk, or a flash memory. Furthermore, the above computer programs may be distributed via, for example, a network without using the storage medium.

### REFERENCE SIGNS LIST

1: system, 10: operation device, 110: operation section, 20: display device, 210: display section, 30: notification device, 310: notification section, 40: control device, 410: acceptance section, 420: control section, 430: storage section

1. A control device comprising:
an acceptance section configured to accept an operation on at least one operation section; and
a control section configured to control a notification section to perform notification matching a situation of a series of continuous operations accepted by the acceptance section.

2. The control device according to claim 1,
wherein the control section causes the notification section to perform at least one of start point notification that indicates an operation start of the series of operations, progress notification that indicates an operation progress situation of the series of operations, and end point notification that indicates an operation end point of the series of operations.

3. The control device according to claim 2, wherein
the operation section accepts a trace operation as one of the series of operations, the trace operation moving an operation object from a first rim in an operation area of the operation section to a second rim different from the first rim, and
the control section causes the notification section to perform at least one of the start point notification, the progress notification, and the end point notification according to a situation of the trace operation accepted by the acceptance section.

4. The control device according to claim 3, wherein
the operation section accepts a swipe operation as one of the trace operations, the swipe operation sliding a target image from one end toward an other end of a display area of a display section arranged separately from the operation section, and
the control section causes the notification section to perform at least one of the start point notification, the progress notification, and the end point notification based on the swipe operation accepted by the acceptance section, the start point notification imitating a tactile sense of grabbing the target image, the progress notification imitating a tactile sense of dragging the target image, and the end point notification imitating a tactile sense that the target image cannot be drawn.

5. The control device according to claim 1,
wherein the control section causes the notification section to perform notification that uses at least one of vibration, sound, and light.

6. A system comprising:
at least one operation section;
an acceptance section configured to accept an operation on the operation section;
a notification section configured to perform notification for a user who performs the operation; and
a control section configured to control the notification section to perform notification matching a situation of a series of continuous operations accepted by the acceptance section.

7. A non-transitory computer readable storage medium having a program stored therein, the program causing a computer to realize:
an acceptance function configured to accept an operation on at least one operation section; and
a control function configured to control a notification section to perform notification matching a situation of a series of continuous operations accepted by the acceptance function.
